(19) United States
(12) Patent Application Publication
(10) Pub. No.: US 2002/0143644 A1
(43) Pub. Date: Oct. 3, 2002

(54) Connection tool for connecting analytical applications to electronic document sources

(76) Inventors: Cafer Tosun, Belmont, CA (US); Kok Thim Chew, Redwood City, CA (US)

Correspondence Address: Timothy F. Loomis, Law Offices of Timothy F. Loomis, 2932 Hagen Drive, Plano, TX, 75025, US

(21) Appl. No.: 09/825,004

(22) Filed: Apr. 3, 2001

(51) Int. Cl. G06F 17/24

(52) U.S. Cl. 705/26; 707/513

(57) ABSTRACT

A connection tool to extract information from an electronic document source, for instance an XML source, such as an electronic marketplace, and convert it to a compatible format before providing it to an analytical application, such as a data warehouse system.

### FIELD OF THE INVENTION

This invention relates to providing a connection tool to extract information from an electronic document source, for instance an XML source, such as an electronic marketplace, and convert it to a compatible format before providing it to an analytical application, such as a data warehouse system.

### BACKGROUND OF THE INVENTION

Many different electronic document sources exist these days that exchange or facilitate the exchange of electronic documents. One such source is a business-to-business electronic marketplace. Such an electronic marketplace is typically accessible to businesses through computer networks, such as the Internet. Electronic marketplaces permit their members to purchase and sell products to other members of the marketplace and negotiate such transactions without needing to actually talk to the other members. Electronic marketplaces are computer systems which are generally maintained by: 1) a company for internal use amongst business units; 2) a group of companies that are likely to trade amongst themselves; or 3) a third party hoping to attract members to the marketplace. These systems greatly increase the ease of which members can purchase and sell goods. This leads to a decrease in transaction costs for those involved.

Additionally, analytical applications such as data warehouses exist. Data warehouses are designed to gather data from various sources and perform very fast analyses of the data. Because some users or operators of electronic marketplaces may desire such analyses of transactions occurring on an electronic marketplace or of information present on the electronic marketplace, a connection tool to extract information from an electronic document source, such as an electronic marketplace and convert the format to one used by an analytical application, such as a data warehouse prior to forwarding it onto the application is needed.

### SUMMARY OF THE INVENTION

An embodiment of the present invention provides a connection tool for extracting information from an electronic marketplace and converting the format of that information to that used by a data warehouse.

Another embodiment of the present invention provides an electronic marketplace having a connection tool for extracting information from an electronic marketplace and converting the format of information to that used by a data warehouse.

As such, it is an object of the present invention to permit the extraction of information on an electronic marketplace and convert the format of that information into a format utilized by a data warehouse.

It is a further object of the present invention to permit an electronic marketplace to extract certain information therein and convert the format of that information into a format utilized by a data warehouse.

### BRIEF DESCRIPTION OF THE DRAWINGS

FIG. 1 is a block diagram of an connection tool according to an embodiment of the present invention.

FIG. 2 is a block diagram of an electronic marketplace having a connection tool according to an embodiment of the present invention.

FIG. 3 is a block diagram of an electronic marketplace having a connection tool according to another embodiment of the present invention.

FIG. 4 is a block diagram of an electronic marketplace having a connection tool according to yet another embodiment of the present invention.

### DESCRIPTION OF THE PREFERRED EMBODIMENTS

The present invention will be better understood by reference to the accompanying drawings.

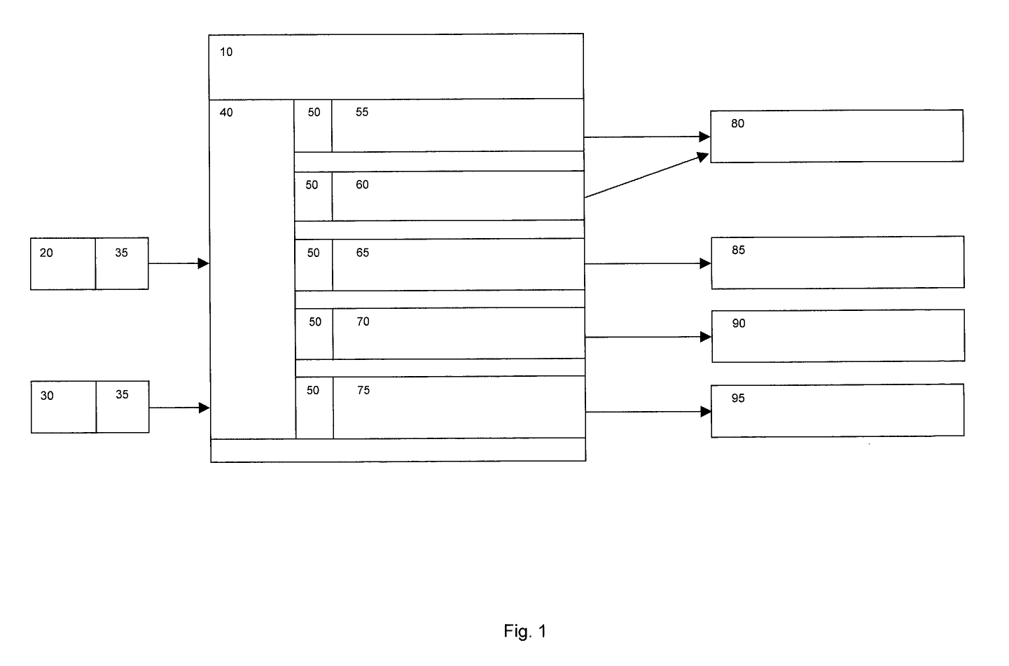

A connection tool according to an embodiment of the present invention is shown in FIG. 1. Connection tool 10 is fed data, such as XML documents, by application 20 which may reside on an electronic marketplace or at another location and by electronic marketplace router 30. Preferably, a broker interface 35 is provided on each application 20 and on the marketplace router 30 for transporting the XML documents to the connection tool 10. Broker interface 35 permits marketplace integrators to call the connection tool regardless of how it is deployed within the electronic marketplace.

Broker interface 35 can be implemented through the creation of a message format. This format can be based on MIME and specify header information and a message body consisting of an XML document. Broker interface 35 supports the exchange of messages between server 40 and application 20 or marketplace router 30 using a variety of transport protocols such as HTTP, HTTPS, RMI, SOAP or JMS and provide for guaranteed delivery of the message. Broker interface 35 consists of help classes and JavaMail. If replies are desired from the connection tool 10, a reply message can be handled from application 20 and marketplace router 30.

The documents sent by application 20 or marketplace router 30 are received by server 40. Server 40 manages the forwarding of incoming documents to interested listeners 55, 60, 65, 70, and 75 through a document subscription model. All listeners subscribe to a set of documents identified by header attributes, such as document source, document type and document version. Preferably, each listener can subscribe to multiple sets of message header attributes. Once a listener receives a document, it is responsible for the extraction of information from the document. Thus, information from documents is filtered based on header attributes, for example document type.

Listener interface 50 provides an interface between server 40 and the connection tool 10 outputs. Listener interface 50 can be implemented through the creating of a Java class. During initialization of connection tool 10, the connection tool 10 looks up an XML property file and instantiates all listeners listed in the XML property file. The listener objects receive the Server instance and also a Thread Pool object for performance reasons.

An inner ThreadJob class can be created to run the time consuming extraction and business processes. The Thread Pool will execute this object to improve performance. The Thread Pool can be used to run the XSL extraction process.

Each listener 55, 60, 65, 70 and 75 (discussed below) must include a listener interface 50 in order to communicate with server 40. Server 40 keeps track of all document attributes that listeners are interested in and knows to which listener each document will be forwarded. Server 40 will forward a copy of the message including the document to each listener interested in that particular document. The listener will in turn extract information from the XML document using XSLT.

Deployment of these listeners 55, 60, 65, 70 and 75 can be done via a XML property file. Essentially, this XML file provides a means for an administrator to deploy different listeners or add new document attributes to which the listeners are subscribing.

Connection tool 10 should preferably provide a standard document listener interface implementation so that a marketplace integrator will only need to write XSL to extract data from an XML document message and not have to deal with the Java implementation of document listeners themselves. Through this implementation, the marketplace operator can write and test their listener via tools like XMLSpy on their desktop. They can deploy the XSL files later by configuring the connection tool XML property file.

Different extraction XSLT schemas can be devised to form the listeners that extract and convert the information. Purchase order listener 55, purchase order master data listener 60, sales order listener 65, sales order acknowledgement 70 and invoice listener 75 shown in FIG. 1 are examples of such schemas. Each of these schemas can convert information into the format utilized by a data warehouse but extract information from different document types. Purchase order listener 55 extracts information from purchase order documents. Purchase order master data listener 60 extracts master data information from purchase order documents. Sales order listener 65 extracts information from sales order documents. Sales order acknowledgement listener 70 extracts information from sales order acknowledgement documents. Invoice listener 75 extracts information from invoice documents. Because each listener can essentially listen to multiple document attributes, such as multiple document types, the listeners mentioned above could alternatively be deployed into a single listener if the end point (80, 85, 90, 95) for each is the same. This will reduce the number of listeners deployed in connection tool 10.

If the information desired to be analyzed by the data warehouse relates to purchase orders placed and acknowledged, purchase order listener 55 and purchase order master data listener 60 can forward information to data warehouse 80 as shown in FIG. 1. Sales order listener can output to database 85, for example. Sales order acknowledge 70 can be output to a third party service 90, for example. Invoice listener 75 can be output to an order management service within the electronic marketplace, for instance.

The connection tool 10 can provide standard listeners which transform the XML document into a schema used by a data warehouse, such as BWXML schema for Business Warehouse by SAP, A. G., and to forward that converted document to the business warehouse or to an existing electronic marketplace infrastructure.

BWXML schema is used as a “data format black box” to load data to the data warehouse. BWXML permits the utilization of the power of XML to describe the metadata of data (e.g., to describe the field type, length, data object, etc.). With this metadata information, an XML receive function module on the data warehouse should be able to create data source automatically from BWXML if it is not already in existence in the data warehouse.

The BWXML schema can be created through the use of a <docheader> subtree, a <structure> subtree and a <table> subtree.

The <docheader> subtree structure is used to describe the XML document original. This subtree consists of <datasource>, <docsource>, <doctype> and <docver>. <datasource> is used to indicate the data warehouse data source to which the information is destined. <docsource> is used to describe the XML schema source or infrastructure source. <doctype> is used to indicate the document type (e.g., purchase order, sales order, opportunity, etc.). <docver> is used to indicate the document type version number.

The <structure> subtree is the metadata for the data of the <table> subtree. The <structure> subtree describes how the data structure should look. In theory, this subtree structure allows the data warehouse's XML receiver function module to create a datasource automatically.

The <table> subtree will contain the actual extracted data from the XML documents (e.g., purchaseorder/salesorder) <row></row> will be a single record so to speak and the total number of <fieldvalue></fieldvalue> pairs should be the same as what is described in <structure> subtree.

A few different embodiments of electronic marketplaces having connection tools according to the present invention are now presented. Certain of the embodiments are better suited for use under certain circumstances as will be described below.

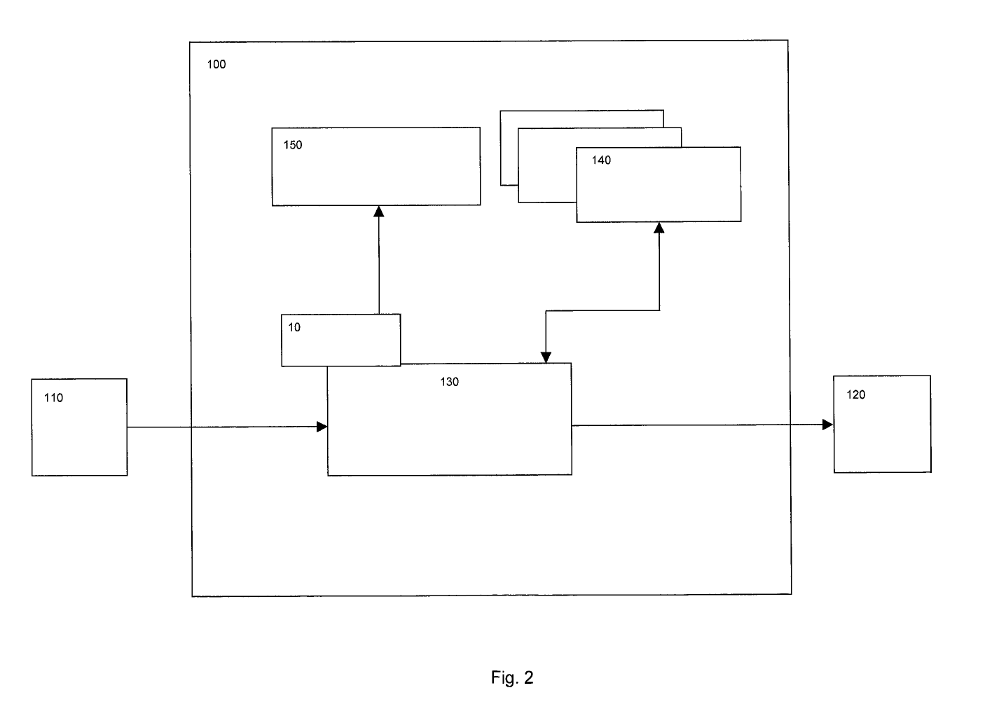

FIG. 2 depicts an electronic marketplace having a connection tool according to an embodiment of the present invention. Electronic marketplace 100 connects user 110 to user 120 to enable business-to-business electronic commerce between them. During such a transaction, an XML document from user 110 flows into electronic marketplace 100 and to master router 130. Master router 130 can route the document to any of a number of business services 140. Connection tool 10 can be connected to master router 130 so that it extracts and forwards data to the data warehouse 150 transparent from the business services 140 and user applications existing at users 110 and 120. Data warehouse 150 can be located within electronic marketplace 100, as pictured, or alternatively, external to electronic marketplace 100. Under the embodiment of FIG. 2, it is easy to manage deployment of XSL listeners within connection tool 10 because connection tool 10 exists in only one place on electronic marketplace 100.

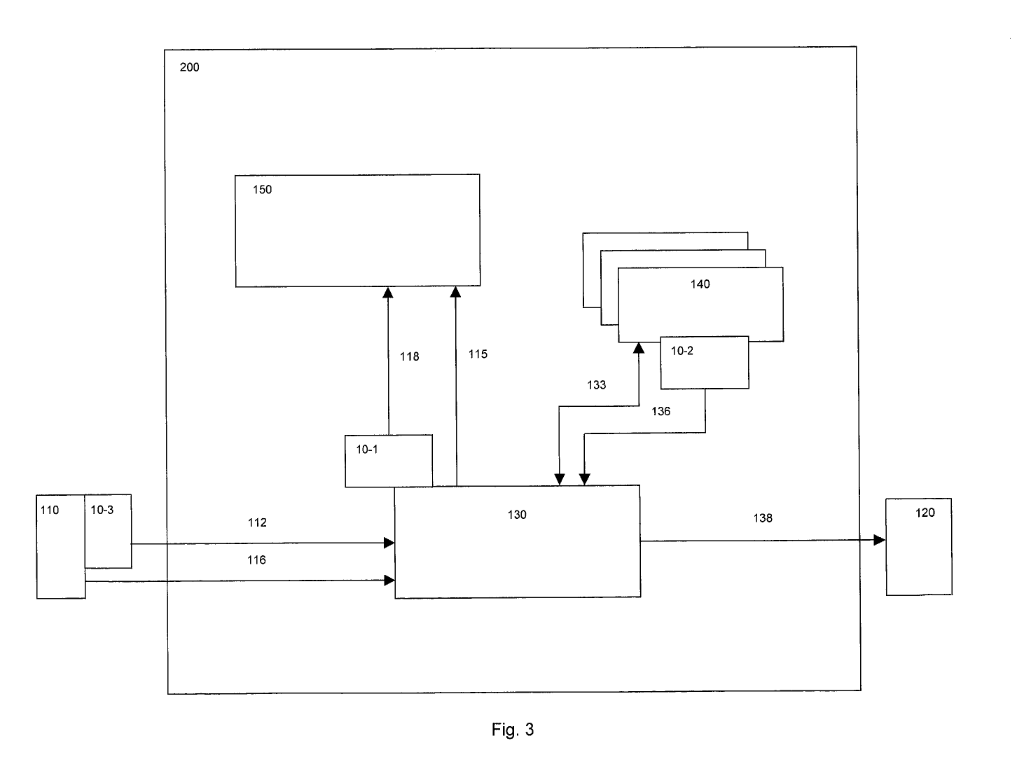

FIG. 3 shows another embodiment of an electronic marketplace having a connection tool 10. Electronic marketplace 200 connects user 110 to user 120 to enable business-to-business electronic commerce between them. User 110 is outfitted with connection tool 10-3. When user 110 is transferring a document to marketplace 130 in which data warehouse 150 is interested, the document can be converted by connection tool 10-3 prior to it being transferred to electronic marketplace 200. Thus, the document being sent to electronic marketplace 200 is in the format used by data warehouse 150 and can be encrypted prior to sending and decrypted after data extraction by data warehouse 150. Because it is already in the format used by data warehouse 150, it can be sent directly to data warehouse 150 without the need to convert the format of the document through router 130 via lines 112 and 115. Alternatively, a direct line can connect connection tool 10-3 with data warehouse 150 bypassing router 130. If the document is not one in which data warehouse is interested, it can be sent via line 116 without being converted by connection tool 10-3.

Connection tool 10-2 is provided to convert documents being handled by business services 140 in which data warehouse 150 is interested. These documents can flow through connection tool 10-2 to marketplace router 130 via line 136 and on to data warehouse 150 through line 115. Alternatively, a direct connection from connection tool 10-2 to data warehouse 150 can be provided. Line 133 connects business services 140 to router 130 for documents in which data warehouse is not interested.

As in the embodiment of FIG. 2, connection tool 10-1 can be connected to master router 130 so that it extracts and forwards data to the data warehouse 150 that has not yet been converted by another connection tool. Also as in the embodiment of FIG. 2, data warehouse 150 can be located internally or externally to electronic marketplace 100. Line 138 connects router 130 to user 120.

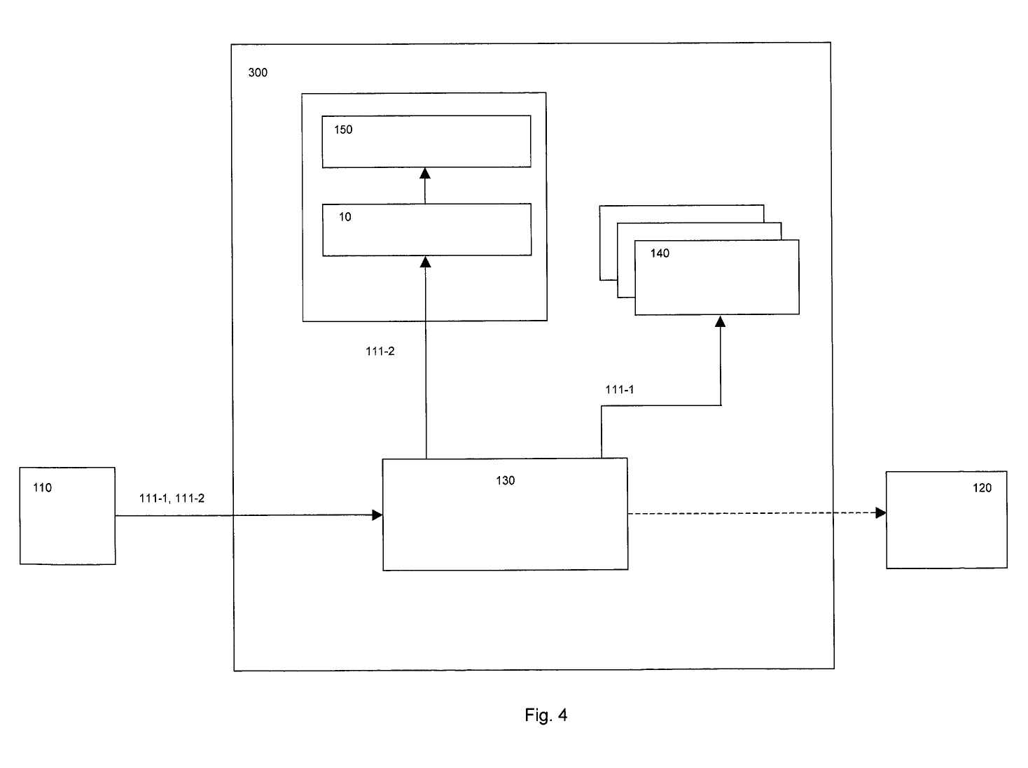

FIG. 4 shows yet another embodiment of an electronic marketplace having a connection tool. Electronic marketplace 300 connects user 110 to user 120 to enable business-to-business electronic commerce between them. During such a transaction, two copies of an XML document 111-1 and 111-2 are sent from user 110 into electronic marketplace 300 and on to master router 130. Copy 111-2 is sent with connection tool 10 listed as the intended recipient and thus is routed to connection tool 10 by master router 130. Connection tool 10 extracts, converts and forwards data to the data warehouse 150. As with the embodiments of FIGS. 2 and 3, data warehouse 150 can be located internally or externally to electronic marketplace 100. Connection tool 10 is connected to master router 130 as an addressee. Under the embodiment of FIG. 4, like the embodiment of FIG. 2, only a single connection tool is necessary and thus XSL listeners only need to be deployed in one location, simplifying maintenance. Also the applications at users 110 and 120 do not need to be connection tool-aware, but just treat connection tool 10 as a business service.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. A connection tool, said connection tool being capable of extracting data from documents on an electronic marketplace and converting a format of said data to be compatible with a data warehouse, comprising:
a server, said server accepting said document from said electronic marketplace and managing extraction of information from said documents based upon document subscriptions;
a listener interface, said listener interface forming an interface between said server and an output of said connection tool;
at least one extraction schema, said at least one extraction schema extracting said information and formatting said information so as to create said output.

2. A connection tool according to claim 1, wherein said output comprises information extracted from a predetermined document type and is sent to subscribers of said predetermined document type.

3. A connection tool according to claim 1, wherein said at least one extraction schema comprises a purchase order listener.

4. A connection tool according to claim 1, wherein said at least one extraction schema comprises a purchase order acknowledgement listener.

5. A connection tool according to claim 1, wherein said connection tool comprises a plurality of extraction schemas, said plurality of extraction schemas comprising a purchase order listener, a purchase order acknowledgement listener, a sales order listener, a sales order acknowledgement listener and an invoice listener.

6. A connection tool according to claim 1, wherein said documents are XML documents.

7. A connection tool according to claim 1, wherein said listener interface can be configured via an XML property file.

8. An electronic marketplace for facilitating electronic commerce between a plurality of users through the exchange and processing of electronic documents comprising:
a plurality of business services, said plurality of business services comprising applications facilitating electronic commerce;
a router, said router routing said electronic documents within said electronic marketplace;
a connection tool, said connection tool being capable of extracting data from said documents and converting a format of said data to be compatible with a data warehouse.

9. An electronic marketplace as in claim 10 wherein said connection tool comprises:
a server, said server managing extraction of information from said electronic documents;
a listener interface, said listener interface forming an interface between said server and an output of said connection tool;
at least one extraction schema, said at least one extraction schema extracting said information and formatting said information to create said output.

10. An electronic marketplace as in claim 8, further comprising a data warehouse.

11. An electronic marketplace as in claim 8, wherein said data warehouse is remotely located from said electronic marketplace.

12. An electronic marketplace as in claim 8, wherein said router copies documents passing through it and provides said copies to said connection tool.

13. An electronic marketplace as in claim 12, wherein said router provides said copies to said connection tool regardless of an intended destination of said documents.

14. An electronic marketplace as in claim 8, wherein said users send at least two copies of said documents to said electronic marketplace, a first copy indicating a destination within said business services and said second copy indicating a destination of said connection tool, said router routing documents according to said indicated destinations.

15. An electronic marketplace as in claim 8, wherein documents arriving at said electronic marketplace from said users are in a first format, said first format being compatible with said data warehouse, said connection tool converts said documents to a second format, said second format being compatible with said business services, prior to sending said documents to said business services and converts second format documents exiting said business services back to said first format prior to sending said second format documents to said router.
